(19) United States
(12) Patent Application Publication
(10) Pub. No.: US 2015/0148718 A1
(43) Pub. Date: May 28, 2015

(54) MASSAGE DEVICE

(71) Applicant: Fun Factory GmbH, Bremen (DE)

(72) Inventor: Norbert Eigler, Meinerzhagen (DE)

(21) Appl. No.: 14/552,239

(22) Filed: Nov. 24, 2014

(30) Foreign Application Priority Data
Nov. 22, 2013 (DE) 202013010462.7

(51) Int. Cl. A61H 23/02; A61H 15/00

(52) U.S. Cl. CPC A61H 23/02; A61H 15/0085; A61H 2201/0169
USPC 601/46

(57) ABSTRACT

A massage device includes a substantially cylindrical housing, and arranged within the housing, electro-mechanical means for generating mechanical vibrations, electronic means for driving the means for generating mechanical vibrations, and a power source is connected to the means for generating mechanical vibration and to the electromechanical means, wherein the means for generating mechanical vibrations includes at least one cylindrical member, a ferromagnetic core which is coaxial with a cylindrical member axis of the cylindrical member and is displaceably guided, and at least one coil element having a coil axis arranged in parallel or coaxially to the cylindrical member and the cylindrical member formed from a paperboard or cardboard material.

### FIELD OF THE INVENTION

The novelty relates to a massage device, comprising a substantially cylindrical housing, electro-mechanical means arranged in the housing (and optionally fixedly or rigidly connected to the housing) for generating mechanical vibrations, electronic means arranged in the housing for controlling the means for generating mechanical vibrations, and an energy source, which is connected to the means for generating mechanical vibrations and to the electro-mechanical means, the means for generating mechanical vibrations comprising at least one cylinder member, one ferromagnetic core, which is slidably guided coaxially with an axis of the cylinder member, and at least one coil element, the coil axis of which is arranged parallely to or coaxially with the cylinder member and surrounds the cylinder member or is integrated therein. The novelty is for example used for sexual stimulation.

### PRIOR ART AND BACKGROUND OF THE INVENTION

A massage apparatus of the type mentioned above is known for example from the document WO 2009/152813. In the massage device known so far, the cylinder member is formed, for example, of a plastic material.

In massage devices for the purposes mentioned above, it is generally desirable that they can be operated very quietly, preferably virtually noiselessly. Although the prior art massage device is characterized already by a comparatively very low noise level, yet a further improvement seems desirable.

### TECHNICAL PROBLEM

It is, therefore, the technical problem of the novelty to provide a massage device that works largely noiselessly.

### SUMMARY OF THE INVENTION

To solve this technical problem, the novelty teaches that that the cylinder member is formed from a paperboard or cardboard material.

Surprisingly, a particularly low noise level is achieved with a cylinder member formed from a paperboard or cardboard material. Without being bound by theory, it seems that a material made of fibers and/or filaments has a relatively low body-borne sound conduction.

In addition, there are benefits in that the cylinder member can be produced in a particularly inexpensive manner from an equally inexpensive material. It is also surprising that a paperboard or cardboard material seems to be very abrasion-resistant with respect to the relative movements of the core, which could be found out in long-term experiments. Even after several hundred hours of operation, no significant wear was observed, which could adversely affect operational reliability. Apparently, the inner surface of the cylinder member produced with this material represents a very good and slidable mating with the metallic material of the core, as well as with any coatings of plastic material (if equipped), which encase the core.

A preferred embodiment is characterized in that the paperboard or cardboard material has a weight per surface area in the range from 150 g/m² to 1,200 g/m², particularly from 400 g/m² to 800 g/m².

An extremely high abrasion resistance is achieved, when the paperboard or cardboard material has a cast-coated or pigment-coated surface, at least inside the cylinder.

Specifically, the paperboard or cardboard material may be formed of at least two layers, which are couched, and/or be designed as a composite material and have one or more layers or films made of a synthetic organic polymeric material, the layer of polymeric material being provided on the inside of the cylinder, on the outside of the cylinder, or as an intermediate layer. In particular the last-mentioned embodiment in a composite structure can improve the long-term dimensional stability.

Preferably, the paperboard or cardboard material is calendered. It is recommended that the running direction for calendering in the finished cylinder member is substantially parallel to the movement direction of the core.

In the following, further optional aspects of the massage device according to the novelty are explained in detail.

With a dimensioning of a mass relation m1:m2 in the range from 1:100 to 1:3, where m1 is the mass of the core and m2 is the total mass of the massage device, it is achieved, on the one hand, that due to its inertia, the massage device carries out an overall vibration in directions in parallel to the axis of the cylinder member, and that with a considerable stroke. Furthermore, the means used for generating mechanical vibrations can be operated virtually noiselessly and in frequency ranges being advantageous for massage purposes.

It is preferred that the mass ratio m1:m2 is in the range from 1:50 to 1:3, in particular from 1:20 to 1:3, in particular from 1:10 to 1:3. In these contexts, it is useful if the mass m1 is in the range from 10 to 300 g, preferably 15 to 200 g, most preferably 20 to 100 g. In the context of the novelty, it is preferred that the stroke of the core in the directions in parallel to the axis of the cylinder member is in the range from 5 to 150 mm, preferably 10 to 100 mm, most preferably 10 to 60 mm.

In the context of the novelty, it is further preferred that the electronic means control the means for generating mechanical vibrations at a frequency in the range from 0.1 to 50 Hz, preferably from 0.1 to 20 Hz, most preferably from 0.3 to 10 Hz, in particular from 0.3 to 5 Hz.

The means for generating mechanical vibrations comprise: a cylinder member, in which the core is guided in parallel to an axis of the cylinder member, especially coaxially with the axis of the cylinder member, at least one excitation coil, the coil axis being arranged coaxially with the cylinder member and surrounding the cylinder member, and one elastically deformable or magnetic impact member at each end of the cylinder member and arranged in the interior thereof. The axis of the cylinder member is substantially in parallel to or coaxial with the cylinder axis of the housing. The core may be formed ferromagnetic only, but may also be magnetized (permanently or non-permanently). Advantageously, the transitions between the front faces and the circumferential surface of the core are rounded, for example having a radius of at least 0.1 mm, in particular at least 0.5 mm. The elastically deformable impact elements in the interior of the cylinder member and at the ends thereof limit the stroke of the core and cushion the impact thereof on the ends of the cylinder member.

Virtually all rubber-elastic materials, but also substantially elastically deformable foam materials made from organic polymers may be used. In the case of magnetic impact elements, the arrangement is such that the impact elements magnetically repel the core.

In a preferred embodiment, two excitation coils being mutually coaxial and spaced apart in the direction of the axis of the cylinder member are provided. These are alternately energized so that the core is attracted from the respective end position of the stroke into the opposite direction. In the case of a magnetized core, the two coils are controlled with opposite polarity.

The cylindrical housing suitably has an outer wall formed from a physiologically acceptable material. For this purpose, in principle, all the polymer materials being usual in the medical field can be used, including, in particular, silicone plastics, latex, polyolefins, and the like.

The energy source is suitably configured as a replaceable battery or accumulator battery. In the latter case, it is recommended that the electronic means additionally comprise a charging circuit for the accumulator battery, so that the accumulator battery of the massage device can be recharged after use by a conventional power supply. For this purpose, then, the housing has an electrical plug connector for the connection of the charger.

Furthermore, it is preferred that the electronic means are connected to at least one control component, by means of which the frequency and/or stroke of the mechanical vibrations of the core can be adjusted or controlled in steps or without steps. These control components can be arranged in or on the massage device, or in an end region of the housing or at a front face of the housing, and may be adapted for manual operation. In the simplest case, there is one or more rotary buttons, for example potentiometers. Alternatively, it is also possible that the control components are arranged at a distance from the housing and are wired or wirelessly connected to the electronic means. In the latter case, a receiver is then integrated in the housing, which is set up for communication with a separate transmitter, the transmitter then including the manually operable control member.

The term of the substantially cylindrical housing is not limited to an exactly cylindrical shape. Rather, the cross-section of the circular shape may vary. Furthermore, the cylinder axis may extend in a non-linear manner. Finally, at least one front face of the cylinder is preferably not flat, but rounded, and in particular, for example, on the front end modeled to a male member. The outer surface of the housing may be not only smooth, but may also comprise a topography, for example, regularly or irregularly spaced ribs.

### BRIEF DESCRIPTION OF THE DRAWINGS

In the following, the novelty will be explained with reference to figures illustrating an example of execution only. There are:

FIG. 1: an outside view of a massage device according to the novelty, partially cut open, and

FIG. 2: a diagrammatical cross section of a vibration generator used according to the novelty.

### DETAILED DESCRIPTION OF THE INVENTION

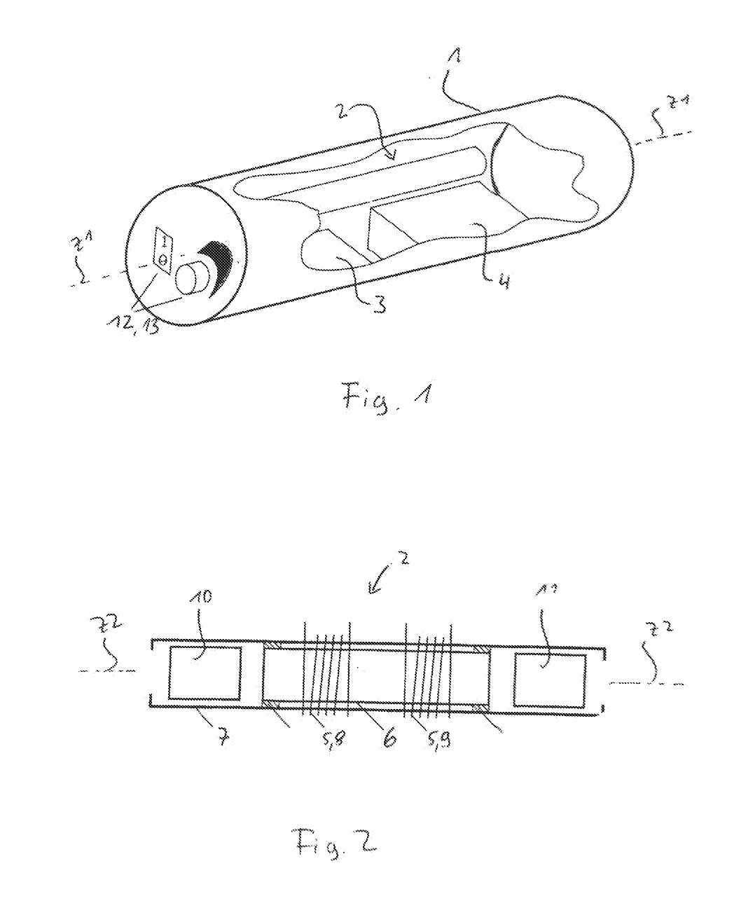

In FIG. 1 can be seen that the massage unit has a substantially cylindrical housing 1. In the housing 1, electro-mechanical means 2 for generating mechanical vibrations are arranged. Furthermore, the housing contains electronic means 3 for controlling the means 2 for generating mechanical vibrations. Finally, an energy source 4 is provided in the housing 1, which is connected to the means 2 for generating mechanical vibrations as well as to the electronic means 3. Different from the representation in FIG. 1, the electro-mechanical means 2 for generating mechanical vibrations may also be coaxial with the housing 1. The energy source 4 and the electronic means 3 for controlling may be provided on or in one end of the housing 1, for example as a handle part.

In FIG. 2 can be seen that the means 2 for generating mechanical vibrations include at least one coil element 5, in the embodiment comprising excitation coils 8, 9 and a movably guided ferromagnetic core 6. Specifically, a cylinder member 7 is provided that has a low magnetic permeability, and the core 6 is guided therein in parallel to an axis Z2 of the cylinder member. The cylinder member is made of a paperboard material having a thickness of about 1.5 mm.

A comparative analysis of FIGS. 1 and 2 shows that the axis Z2 of the cylinder member is parallel to the axis Z1 of the cylinder member. This causes the core 6 to move in parallel to the cylinder axis Z1 and is guided in the cylinder member 7. Different from the representation of FIG. 1, the axis Z2 of the cylinder member may also be coaxial with the cylinder axis Z1. In FIG. 1 can further be seen that a control component 12 designed as a rotary button is arranged at one end of the housing 1, by means of which the frequency and/or the stroke of the mechanical vibrations of the core 6 can be adjusted and controlled. Alternatively, a button may be provided, by means of which said control parameters can be activated in different programs, for example, by sequentially pressing such a button, thereby a different program being activated. Further, there is an on/off switch 13, which can also be implemented as a button.

It is understood that, within the scope of the novelty, the cylinder member 7 preferably is rigidly connected to the housing 1. Thereby, the mechanical vibration of the core 6 is transferred in an optimum manner to the housing 1.

Referring once again to FIG. 2, it can be seen that two excitation coils 8, 9 being mutually coaxial and spaced apart in the direction of the axis Z2 of the cylinder component are provided. Furthermore, elastically deformable impact elements or end magnets 10, 11 can be seen that are arranged on the inside and on each end of the cylinder member 7. In the case of a magnetized core 6, the two excitation coils 8, 9 are activated alternately and with opposite polarity by the electronic means 3. The impact elements 10, 11, for example, consist of a foam material or a permanently magnetic material.

A massage device according to the invention typically has a core 6 with a mass m1, which is in the range from 10 to 300 g, in particular from 15 to 200 g, preferably from 20 to 80 g. The total mass m2 of the massage device is typically in the range from 100 to 1,000 g, in particular from 150 to 500 g, preferably from 200 to 400 g. The electronic means 3 control the means 2 for generating mechanical vibrations at a frequency typically being in the range from 0.3 to 5 Hz. Typically, the control of the excitation coils 8, 9 occurs with a rectangular function or a trapezoidal function of high edge steepness. This induces high accelerations of the core 6 and corresponding counter-movements of the housing 1. The stroke H of the core 6 in directions in parallel to the cylinder axis is typically in the range from 5 to 150 mm. The stroke H of the core 6 corresponds to the distance of the mutually facing surfaces of the impact elements 10, 11, minus the length of the core 6 in the direction of the axis Z2 of the cylinder component. Preferably, the stroke is in the range from 20 to 80 mm.

1. A massage device comprising:
a substantially cylindrical housing,
electro-mechanical means arranged in the housing for generating mechanical vibrations,
electronic means arranged in the housing for controlling the electro-mechanical means for generating mechanical vibrations, and
an energy source, which is connected to the electro-mechanical means for generating mechanical vibrations and to the electronic means,
the electro-mechanical means for generating mechanical vibrations comprising at least one cylinder member, one ferromagnetic core, which is slidably guided coaxially with an axis of the cylinder member, and at least one coil element, the coil axis of which is arranged parallely to or coaxially with the cylinder member and surrounds the cylinder member or is integrated therein, wherein the cylinder member is formed from a paperboard or cardboard material.

2. The massage device according to claim 1, wherein the paperboard or cardboard material has a weight per surface area in the range from 150 g/m² to 1,200 g/m².

3. The massage device according to claim 1, wherein the paperboard or cardboard material has a cast-coated or pigment-coated surface, at least inside the cylinder.

4. The massage device according to claim 1, wherein the paperboard or cardboard material is formed of at least two layers, which are couched, and/or is designed as a composite material and has one or more layers or films made of a synthetic organic polymeric material, the layer of polymeric material being provided on the inside of the cylinder.

5. The massage device according to claim 1, wherein the paperboard or cardboard material is calendered.

6. The massage device according to claim 1, wherein the paperboard or cardboard material has a weight per surface area in the range from 400 g/m² to 800 g/m².

7. The massage device according to claim 1, wherein the paperboard or cardboard material is formed of at least two layers, which are couched, and/or is designed as a composite material and has one or more layers or films made of a synthetic organic polymeric material, the layer of polymeric material being provided on the outside of the cylinder.

8. The massage device according to claim 1, wherein the paperboard or cardboard material is formed of at least two layers, which are couched, and/or is designed as a composite material and has one or more layers or films made of a synthetic organic polymeric material, the layer of polymeric material being provided as an intermediate layer.

9. The massage device according to claim 2, wherein the paperboard or cardboard material is formed of at least two layers, which are couched, and/or is designed as a composite material and has one or more layers or films made of a synthetic organic polymeric material, the layer of polymeric material being provided on the inside of the cylinder.

10. The massage device according to claim 3, wherein the paperboard or cardboard material is formed of at least two layers, which are couched, and/or is designed as a composite material and has one or more layers or films made of a synthetic organic polymeric material, the layer of polymeric material being provided on the inside of the cylinder.

11. The massage device according to claim 2, wherein the paperboard or cardboard material is formed of at least two layers, which are couched, and/or is designed as a composite material and has one or more layers or films made of a synthetic organic polymeric material, the layer of polymeric material being provided on the outside of the cylinder.

12. The massage device according to claim 3, wherein the paperboard or cardboard material is formed of at least two layers, which are couched, and/or is designed as a composite material and has one or more layers or films made of a synthetic organic polymeric material, the layer of polymeric material being provided as an intermediate layer.

13. The massage device according to claim 2, wherein the paperboard or cardboard material is formed of at least two layers, which are couched, and/or is designed as a composite material and has one or more layers or films made of a synthetic organic polymeric material, the layer of polymeric material being provided on the outside of the cylinder.

14. The massage device according to claim 3, wherein the paperboard or cardboard material is formed of at least two layers, which are couched, and/or is designed as a composite material and has one or more layers or films made of a synthetic organic polymeric material, the layer of polymeric material being provided as an intermediate layer.
